(19) United States
(12) Patent Application Publication
(10) Pub. No.: US 2026/0236767 A1
(43) Pub. Date: Aug. 13, 2026

(54) MODEL TRAINING METHOD, MODEL DEPLOYMENT METHOD, ELECTRONIC DEVICE, AND STORAGE MEDIUM

(71) Applicant: Beijing Baidu Netcom Science Technology Co., Ltd., Beijing (CN)

(72) Inventors: Yinqi YANG, Beijing (CN); Junyuan SHANG, Beijing (CN); Shuohuan WANG, Beijing (CN); Yu SUN, Beijing (CN)

(21) Appl. No.: 19/365,126

(22) Filed: Oct. 21, 2025

(30) Foreign Application Priority Data
May 29, 2025 (CN) 202510716025.X

(51) Int. Cl. G06N 3/08; G06N 3/0499

(52) U.S. Cl. CPC G06N 3/08; G06N 3/0499

(57) ABSTRACT

A model training method, a model deployment method, an electronic device, and a storage medium are provided, which relate to a field of artificial intelligence technology, in particular to fields of large model technology and deep learning technology. The model training method includes determining at least one module scale information according to preset model scale information; determining at least one to-be-trained module according to the at least one module scale information and a plurality of initial modules of an initial model, where the to-be-trained module includes a to-be-trained parameter determined from the initial module according to the module scale information; and training the at least one to-be-trained module according to training sample data to obtain at least one trained module, where the training sample data is obtained from at least one of text sample data, image sample data, audio sample data, or video sample data.

This application claims the benefit of priority to Chinese Patent Application No. 202510716025.X, filed on May 29, 2025. The entire contents of this application are hereby incorporated herein by reference.

### TECHNICAL FIELD

The present disclosure relates to a field of artificial intelligence technology, and in particular to fields of large model technology and deep learning technology. More specifically, the present disclosure provides a model training method, a model deployment method, an electronic device, a storage medium.

### BACKGROUND

With the development of artificial intelligence technology, the scale (shape) of deep learning models is increasing. The performance of deep learning models is continuously improved along with the increase of the scale of the models. In order to balance model inference capability and hardware resource overhead, the model scale may be adjusted when deploying the deep learning model to an application scenario.

### SUMMARY

The present disclosure provides a model training method, a model deployment method, an electronic device, a storage medium.

According to an aspect of the present disclosure, a model training method is provided, including: determining at least one module scale information according to preset model scale information; determining at least one to-be-trained module according to the at least one module scale information and a plurality of initial modules of an initial model, where the to-be-trained module includes a to-be-trained parameter determined from the initial module according to the module scale information; and training the at least one to-be-trained module according to training sample data to obtain at least one trained module, where the training sample data is obtained from at least one of text sample data, image sample data, audio sample data, or video sample data.

According to another aspect of the present disclosure, a model deployment method is provided, including: determining a to-be-deployed model from a target model according to preset model scale information; deploying the to-be-deployed model to a hardware device for the to-be-deployed model, where the target model is obtained by training an initial model through: determining at least one module scale information according to the preset model scale information; determining at least one to-be-trained module according to the at least one module scale information and a plurality of initial modules of an initial model, where the to-be-trained module includes a to-be-trained parameter determined from the initial module according to the module scale information; and training the at least one to-be-trained module according to training sample data to obtain at least one trained module, where the training sample data is obtained from at least one of text sample data, image sample data, audio sample data, or video sample data.

According to another aspect of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to implement the method provided by the present disclosure.

According to another aspect of the present disclosure, a non-transitory computer-readable storage medium having computer instructions therein is provided, where the computer instructions are configured to cause a computer to implement the method provided by the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, wherein:

FIG. 1 shows a flowchart of a model training method according to an embodiment of the present disclosure;

FIG. 2A shows a schematic diagram of an initial model according to an embodiment of the present disclosure;

FIG. 2B shows a schematic diagram of determining a to-be-trained model according to an embodiment of the present disclosure;

FIG. 3A shows a schematic diagram of a plurality of initial attention data blocks according to an embodiment of the present disclosure;

FIG. 3B shows a schematic diagram of an intermediate query parameter matrix according to an embodiment of the present disclosure;

FIG. 4 shows a schematic diagram of an initial feedforward parameter matrix according to an embodiment of the present disclosure;

FIG. 5 shows a flowchart of a model deployment method according to another embodiment of the present disclosure;

FIG. 6 shows a block diagram of a model training apparatus according to an embodiment of the present disclosure;

FIG. 7 shows a block diagram of a model deployment apparatus according to an embodiment of the present disclosure; and

FIG. 8 shows a block diagram of an electronic device for implementing at least one of a model training method or a model deployment method according to an embodiment of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those of ordinary skill in the art should realize that various changes and modifications may be made to the embodiments described herein without departing from the scope and spirit of the present disclosure. Likewise, for clarity and conciseness, descriptions of well-known functions and structures are omitted in the following description.

Large-scale deep learning models may also be referred to as large models. The large model may be, for example, a Large Language Model (LLM). Huge-scale large models require significant computing resources and storage resources for inferring and training, and also have high inference latency, and are difficult to be deployed in application scenarios with limited hardware resources. Therefore, models of different scales may be deployed in different application scenarios to balance inference speed and accuracy.

In order to acquire models of different scales, a plurality of models of different scales may be trained separately to meet the requirements of various application scenarios. However, separate training increases the model training cost. If a model needs to undergo large-scale pre-training, the overhead of computing resources will be very high.

Large models may be built based on the Transformer architecture. In order to reduce computing resource overhead, a Matryoshka Transformer (MatFormer) architecture may be used to acquire a plurality of small-scale sub-models from a trained model. The Matryoshka Transformer architecture performs a structured nested design on the Multi-Head self Attention (MHA) layer and the Feed Forward Network (FFN) layer of the Transformer architecture, where smaller sub-models are contained within larger sub-models. Based on the Matryoshka Transformer architecture, a sub-model may be randomly selected for training in a training process. The parameters of the sub-model based on the Matryoshka Transformer architecture may be predetermined. For example, for a plurality attention heads in the Multi-Head self Attention layer, based on the Matryoshka Transformer architecture, the parameters of the 1st to 3rd attention heads may be used as the parameters of the first sub-model, and the parameters of the 4th to 6th attention heads may be used as the parameters of the second sub-model. If the first sub-model is to be trained, the parameters of the 1st to 3rd attention heads are adjusted.

Effective elastic training may be achieved to a certain extent based on the Matryoshka Transformer architecture. However, the parameters of the sub-models based on the Matryoshka Transformer architecture are predetermined, which may result in some parameters not being fully trained, failing to fully utilize the training capability of the large model and possibly affecting the final performance of the large model. In addition, in the forward computation process, based on the Matryoshka Transformer architecture, computation may be performed based on a plurality of sub-models, leading to increased training costs.

Therefore, in order to efficiently deploy a model to an application scenario, the present disclosure provides a model training method, which is described below.

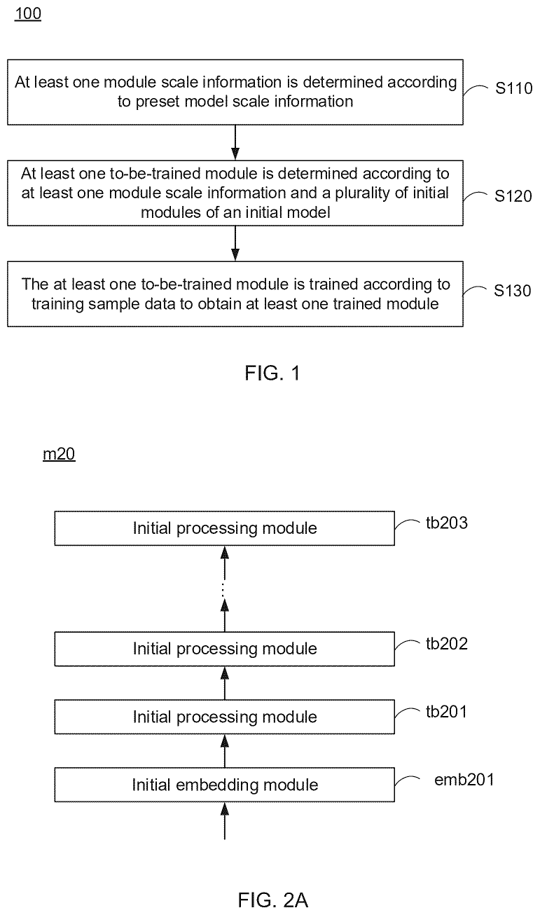

FIG. 1 shows a flowchart of a model training method according to an embodiment of the present disclosure.

As shown in FIG. 1, a method 100 may include operation S110 to operation S130.

In operation S110, at least one module scale information is determined according to preset model scale information.

In embodiments of the present disclosure, the preset model scale information may indicate the scale of a to-be-trained model determined from an initial model. For example, the preset model scale information may indicate that the parameter quantity of the to-be-trained model is 25% of the parameter quantity of the initial model. For another example, the preset model scale information may indicate that the parameter quantity of the to-be-trained model is 50% of the parameter quantity of the initial model.

In embodiments of the present disclosure, the initial model may be a large-scale model. The initial model may include a plurality of initial modules. The initial model may also be referred to as a full model. For example, the initial model may be the above-mentioned large model. A transformer block of the large model may function as an initial module. In addition, an embedding module of the large model may also function as an initial module.

In embodiments of the present disclosure, the module scale information may indicate the scale of to-be-trained parameters in an initial module. For example, if the preset model scale information indicates that the parameter quantity of the to-be-trained model is 25% of the parameter quantity of the initial model, the module scale information may indicate that the to-be-trained parameter quantity in an initial module is 25% of the parameter quantity of the initial module.

In operation S120, at least one to-be-trained module is determined according to at least one module scale information and a plurality of initial modules of an initial model.

In embodiments of the present disclosure, the to-be-trained module includes a to-be-trained parameter determined from the initial module according to the module scale information. For example, taking the module scale information indicating that the to-be-trained parameter quantity in an initial module is 25% of the parameter quantity of the initial module as an example, a plurality of initial parameters may be randomly determined as the to-be-trained parameters from all initial parameters of the initial module. The parameter quantity of the to-be-trained parameters is 25% of the parameter quantity of all initial parameters.

In embodiments of the present disclosure, the number of to-be-trained modules may be less than or equal to the number of the initial modules. The at least one to-be-trained module may serve as the to-be-trained model. The to-be-trained model may be a sub-model of the initial model or may be the entire initial model.

In operation S130, the at least one to-be-trained module is trained according to training sample data to obtain at least one trained module.

In embodiments of the present disclosure, the training sample data is obtained from at least one of text sample data, image sample data, audio sample data, or video sample data. For example, the training sample data may be single-modal sample data or multi-modal sample data. In a case that the training sample data is single-modal sample data, one of text sample data, image sample data, or audio sample data may be used as the training sample data. For another example, video includes data of multiple modalities such as images and audio, and in a case that the training sample data is multi-modal sample data, the video sample data may be used as the training sample data.

In embodiments of the present disclosure, the training sample data is input into the at least one to-be-trained module to obtain a sample result. Loss information may be determined according to the sample result and the label of the training sample data, and the at least one to-be-trained module may be adjusted according to the loss information to obtain the at least one trained module.

Through embodiments of the present disclosure, the module scale information is determined according to the preset model scale information, and further the to-be-trained module is determined according to the module scale information and the initial module. As a result, in a plurality of training rounds, even if the preset model scale information are the same, the module scale information may be different, and the parameters included in a plurality of to-be-trained modules determined according to the same initial module may also be different. In different training rounds, at least one to-be-trained model corresponding to the preset model scale information is not fixed but dynamically determined, such that all parameters of the full model are potentially used as to-be-trained parameters, ensuring that the model parameters may be fully trained and helping to improve the model performance.

Furthermore, through embodiments of the present disclosure, the to-be-trained module is obtained according to the initial module of the initial model. Therefore, only the parameters of the initial model need to be stored in a storage unit, and there is no need to store the respective parameters of a plurality of sub-models, which effectively reduces storage resource overhead. In a training process, forward computation is performed on at least one to-be-trained module determined according to the preset model scale information, that is, forward computation is performed on the basis of one to-be-trained model, which avoids simultaneous forward computation of a plurality of sub-models, reduces the computing resource overhead of each training round, and lowers the hardware requirement threshold for model training.

It may be understood that the method of the present disclosure is described above, and the preset model scale information of the present disclosure will be described below.

In some embodiments, the preset model scale information includes a plurality of preset model scale parameters, and the preset parameter quantity indicated by the preset model scale parameter is less than or equal to the initial parameter quantity of the initial model. For example, the plurality of preset model scale parameters may include a first preset model scale parameter, a second preset model scale parameter, a third preset model scale parameter, and a fourth preset model scale parameter. The first preset model scale parameter may be 25%, which may indicate that the parameter quantity of the to-be-trained model is 25% of the parameter quantity of the initial model; the second preset model scale parameter may be 50%, which may indicate that the parameter quantity of the to-be-trained model is 50% of the parameter quantity of the initial model; the third preset model scale parameter may be 75%, which may indicate that the parameter quantity of the to-be-trained model is 75% of the parameter quantity of the initial model; and the fourth preset model scale parameter may be 100%, which may indicate that the initial model is used as the to-be-trained model.

It may be understood that the preset model scale information of the present disclosure is described above, and some methods of determining the module scale information in the present disclosure will be described below.

In some embodiments, in some implementations of the above-mentioned operation S110, the determining at least one module scale information according to preset model scale information includes: determining a target model scale parameter from the plurality of preset model scale parameters according to a plurality of preset parameter probability values for the plurality of preset model scale parameters. The preset parameter quantity indicated by the target model scale parameter is consistent with the to-be-trained parameter quantity for the at least one to-be-trained module. For example, the first preset parameter probability value for the above-mentioned first preset model scale parameter may be 16.6%, meaning that the probability of using 25% of the parameter quantity of the initial model as the parameters of the to-be-trained model is 16.6%; the second preset parameter probability value for the above-mentioned second preset model scale parameter may be 16.6%, meaning that the probability of using 50% of the parameter quantity of the initial model as the parameters of the to-be-trained model is 16.6%; the third preset parameter probability value for the above-mentioned third preset model scale parameter may be 16.8%, meaning that the probability of using 75% of the parameter quantity of the initial model as the parameters of the to-be-trained model is 16.8%; and the fourth preset parameter probability value for the above-mentioned fourth preset model scale parameter may be 50%, meaning that the probability of using the initial model as the to-be-trained model is 50%. Taking determining the second preset model scale parameter as the target model scale parameter as an example, the parameter quantity of the to-be-trained model determined from the initial model may be 50% of the parameter quantity of the initial model.

In some embodiments, the number of the to-be-trained modules is less than or equal to the number of the initial modules. Thus, the number of the transformer blocks may be reduced to achieve lightweight deployment. For example, if a target scale parameter is 50%, the number of the initial modules is N, where N is an even number greater than 1, then N/2 initial modules may be selected as the to-be-trained modules. For another example, if the target scale parameter is 50% and the number of the initial modules is N, all N initial modules may be used as N to-be-trained modules, and then the scale of each to-be-trained module may be determined. It may be understood that the number of to-be-trained modules may be randomly determined based on the target module scale parameter. It may be understood that through embodiments of the present disclosure, models with different depths (i.e., different numbers of transformer blocks) may be effectively trained, which improves training efficiency. The trained models with different depths may adapt to the deployment requirements of different hardware resources and also help enhance model deployment efficiency.

In some embodiments, in some implementations of the above-mentioned operation S110, the determining at least one module scale information according to preset model scale information further includes: determining at least one module scale information for at least one of the plurality of initial modules according to the target model scale parameter. For example, any module scale information may be consistent with the target model scale information, and taking the target model scale parameter being 50% as an example, the module scale information may indicate that the parameter quantity of the to-be-trained module is 50% of the parameter quantity of the corresponding initial module. For another example, when there are a plurality of module scale information, different module scale information may be different. The plurality of module scale information may include a first module scale information and a second module scale information. The first module scale information may be 40%, indicating that the parameter quantity of the to-be-trained module is 40% of the parameter quantity of the corresponding initial module. The second module scale information may be 60%, indicating that the parameter quantity of the to-be-trained module is 60% of the parameter quantity of the corresponding initial module.

In some embodiments, the determining the at least one module scale information for at least one of the plurality of initial modules according to the target model scale parameter includes: determining latent variable scale information and the at least one module scale information for at least one of the plurality of initial modules according to the target model scale parameter. The latent variable scale information may indicate a scale of latent variables for the to-be-trained module. For example, if the target model scale parameter indicates that the parameter quantity of the to-be-trained model is 50% of the parameter quantity of the corresponding initial model, the latent variable scale information may indicate that the parameter quantity of latent variables for the to-be-trained model is 50% of the parameter quantity of latent variables for the corresponding initial model.

It may be understood that the method of determining the module scale information in the present disclosure is described above, and some methods of determining to-be-trained model will be described below.

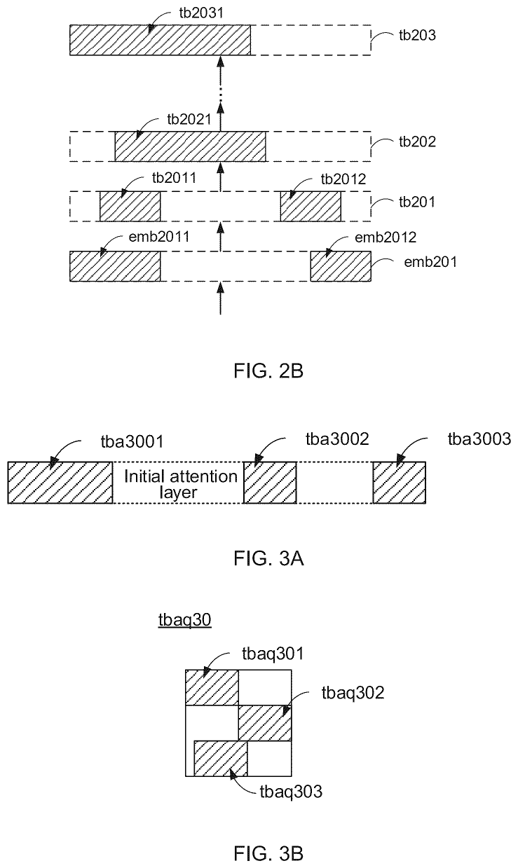

In some embodiments, in some implementations of the above-mentioned operation S120, the determining at least one to-be-trained module according to the at least one module scale information and a plurality of initial modules of an initial model includes: determining a plurality of to-be-trained parameters included in the to-be-trained module from the initial module based on at least one of a plurality of sampling modes according to module scale information for the initial module. The plurality of sampling modes include a random sampling mode. For example, taking the above-mentioned first module scale information being 40% and the first module scale information being used for the first initial module as an example, 40% of the parameters may be randomly sampled from the plurality of initial parameters of the first initial module as the to-be-trained parameters. In an example, if the parameter quantity of the first initial module is 100 megabytes (MB), 40 MB of parameters may be randomly sampled as the to-be-trained parameters. Further description will be made below with reference to FIG. 2A and FIG. 2B.

FIG. 2A shows a schematic diagram of an initial model according to an embodiment of the present disclosure.

As shown in FIG. 2A, an initial model m20 may include a plurality of initial modules. The plurality of initial modules may include an initial embedding module emb201, an initial processing module tb201, an initial processing module tb202, . . . an initial processing module tb203. The initial processing module may be the above-mentioned transformer block.

FIG. 2B shows a schematic diagram of determining a to-be-trained model according to an embodiment of the present disclosure.

As shown in FIG. 2B, the to-be-trained model may be determined from the initial model m20 according to the target scale sampling parameter. Then, description will be made with the target model scale parameter being 50% as an example.

As shown in FIG. 2B, the initial embedding data of the initial embedding module emb201 may include a plurality of initial embedding parameter blocks. The initial embedding parameter block may include a plurality of initial embedding parameters. Among the plurality of initial embedding parameter blocks, the initial embedding parameter block emb2011 and the initial embedding parameter block emb2012 may be used as two to-be-trained embedding parameter blocks. The sum of the parameter quantity of the initial embedding parameter block emb2011 and the parameter quantity of the initial embedding parameter block emb2012 may be 50% of the parameter quantity of the above-mentioned initial embedding module emb201.

As shown in FIG. 2B, the initial processing data of the initial processing module tb201 includes a plurality of initial processing parameter blocks. The initial processing parameter block may include a plurality of initial processing parameters. Among the plurality of initial processing parameter blocks, the initial processing parameter block tb2011 and the initial processing parameter block tb2012 may be used as two to-be-trained processing parameter blocks. The sum of the parameter quantity of the initial processing parameter block tb2011 and the parameter quantity of the initial processing parameter block tb2012 may be 40% of the parameter quantity of the above-mentioned initial processing module tb201. It may be understood that the initial processing module tb201 may be the above-mentioned first initial module, and the module scale information for the initial processing module tb201 may be the above-mentioned first module scale information.

As shown in FIG. 2B, the initial processing data of the initial processing module tb202 includes a plurality of initial processing parameter blocks. The plurality of initial processing parameter blocks may include the initial processing parameter block tb2021. The initial processing parameter block tb2021 may be used as a to-be-trained processing parameter block. The parameter quantity of the initial processing parameter block tb2021 may be 50% of the parameter quantity of the above-mentioned initial processing module tb202.

As shown in FIG. 2B, the initial processing data of the initial processing module tb203 includes a plurality of initial processing parameter blocks. The plurality of initial processing parameter blocks may include the initial processing parameter block tb2031. The initial processing parameter block tb2031 may be used as a to-be-trained processing parameter block. The parameter quantity of the initial processing parameter block tb2031 may be 60% of the parameter quantity of the above-mentioned initial processing module tb203. It may be understood that the initial processing module tb203 may be the above-mentioned second initial module, and the module scale information for the initial processing module tb203 may be the above-mentioned second module scale information.

It may be understood that some methods of determining the to-be-trained module are described above, and some methods of determining the to-be-trained module will be further described below.

In some embodiments, the initial module includes at least one of an initial attention layer or an initial feedforward layer. The to-be-trained module includes at least one of a to-be-trained attention layer or a to-be-trained feedforward layer. For example, the plurality of initial modules may include the above-mentioned initial embedding module and initial processing module. The initial processing module includes at least one of an initial attention layer or an initial feedforward layer. The plurality of initial parameters may include a plurality of initial processing parameters. The plurality of initial processing parameters may include an initial attention parameter and an initial feedforward parameter. The plurality of to-be-trained parameters may include a plurality of to-be-trained processing parameters. The plurality of to-be-trained processing parameters may include a to-be-trained attention parameter and a to-be-trained feedforward parameter. For example, the initial module may include an initial processing module. The initial attention layer may be the above-mentioned multi-head self attention layer. The initial feedforward layer may be the above-mentioned feed forward network layer. The to-be-trained attention layer may be obtained from the initial attention layer. The to-be-trained feedforward layer may be obtained from the initial feedforward layer.

In some embodiments, the to-be-trained parameter of the to-be-trained module may be determined from at least one of the initial attention layer or the initial feedforward layer. It may be understood that attention scale information for the initial attention layer and feedforward scale information for the initial feedforward layer may be determined according to the module scale information for the initial processing module. The sum of the parameter quantity of to-be-trained feedforward parameters indicated by the feedforward scale information and the parameter quantity of to-be-trained attention parameters indicated by the attention scale information may be the parameter quantity of initial processing parameters indicated by the module scale information. Description will be made below with reference to the initial attention layer.

In some embodiments, the determining at least one to-be-trained module according to the at least one module scale information and a plurality of initial modules of an initial model includes: determining to-be-trained attention data of the to-be-trained attention layer from the initial attention layer according to module scale information for the initial module. The to-be-trained attention data includes a plurality of to-be-trained attention parameters.

In some embodiments, the initial attention layer includes initial attention data of each of a plurality of initial attention heads, and the initial attention data includes an initial query parameter matrix, an initial key parameter matrix, and an initial value parameter matrix. The determining to-be-trained attention data of the to-be-trained attention layer from the initial attention layer includes: determining at least one of the initial attention data of at least one of the plurality of initial attention heads as at least one intermediate attention data of at least one to-be-trained attention head; and determining at least one of the to-be-trained attention data from the at least one intermediate attention data. Further description will be made below with reference to FIG. 3A.

FIG. 3A shows a schematic diagram of a plurality of initial attention data blocks according to an embodiment of the present disclosure.

As shown in FIG. 3A, the initial attention layer includes a plurality of initial attention data blocks. The plurality of initial attention data blocks include an initial attention data block tba3001, an initial attention data block tba3002, and an initial attention data block tba3003. The initial attention layer of the initial processing module may include 16 initial attention heads. The module scale information for the initial processing module may be 50%, and 8 initial attention heads may be randomly selected as the to-be-trained attention heads. The initial attention data block tba3001, the initial attention data block tba3002, and the initial attention data block tba3003 include initial attention data of 4 initial attention heads, initial attention data of 2 initial attention heads, and initial attention data of 2 initial attention heads, respectively. The respective initial attention data of the 8 initial attention heads may be used as 8 intermediate attention data. In an example, the 8 intermediate attention data may be used as 8 to-be-trained attention data.

Through embodiments of the present disclosure, any one or more attention heads may be determined from the plurality of attention heads as the to-be-trained attention heads, which improves the flexibility of training and effectively enhances training efficiency.

It may be understood that the intermediate attention data is used as the to-be-trained attention data above. However, the present disclosure is not limited to this, and a part of the intermediate attention data may also be used as the to-be-trained attention data, which will be further described below.

In some embodiments, the intermediate attention data may include an intermediate query parameter matrix, an intermediate key parameter matrix, and an intermediate value parameter matrix. The to-be-trained attention data includes a to-be-trained query parameter matrix, a to-be-trained key parameter matrix, and a to-be-trained value parameter matrix.

In some embodiments, the determining at least one of the to-be-trained attention data from the at least one intermediate attention data includes at least one of: determining at least one intermediate query parameter submatrix in the intermediate query parameter matrix as at least one to-be-trained query parameter submatrix of the to-be-trained query parameter matrix; determining at least one intermediate key parameter submatrix in the intermediate key parameter matrix as at least one to-be-trained key parameter submatrix of the to-be-trained key parameter matrix; or determining at least one intermediate value parameter submatrix in the intermediate value parameter matrix as at least one to-be-trained value parameter submatrix of the to-be-trained value parameter matrix. For example, taking the query parameter matrix as an example, the initial query parameter matrix may be used as the intermediate query parameter matrix. A part or all of the intermediate query parameter matrix may be used as the to-be-trained query parameter matrix. Further description will be made below with reference to FIG. 3B.

FIG. 3B shows a schematic diagram of an intermediate query parameter matrix according to an embodiment of the present disclosure.

As shown in FIG. 3B, an intermediate query parameter matrix tbaq30 may include a plurality of intermediate query parameters. An intermediate query parameter submatrix tbaq301, an intermediate query parameter submatrix tbaq302, and an intermediate query parameter submatrix tbaq303 may be randomly determined from the intermediate query parameter matrix tbaq30 as 3 to-be-trained query parameter submatrices. In an example, matrix elements in the intermediate query parameter matrix tbaq30 other than the intermediate query parameter submatrix tbaq301, the intermediate query parameter submatrix tbaq302, and the intermediate query parameter submatrix tbaq303 may also be set to a preset value (0) to obtain a to-be-trained query parameter matrix. It may be understood that the method of acquiring the to-be-trained key parameter matrix and the to-be-trained value parameter matrix is the same as or similar to the method of acquiring the to-be-trained query parameter matrix from the intermediate query parameter matrix tbaq30, and thus will not be described in detail herein. Through embodiments of the present disclosure, any part of the attention parameters may be used as the to-be-trained attention parameters, which effectively improves training efficiency.

It may be understood that, according to the attention scale information, at least one initial attention data of at least one initial attention head is randomly determined as at least one intermediate attention data of at least one to-be-trained attention head.

It may be understood that some methods of determining the to-be-trained attention parameters are described above, and some methods of determining the to-be-trained feedforward parameters will be described below.

In some embodiments, according to the module scale information for the initial module, the to-be-trained feedforward data of the to-be-trained feedforward layer may be determined from the initial feedforward layer.

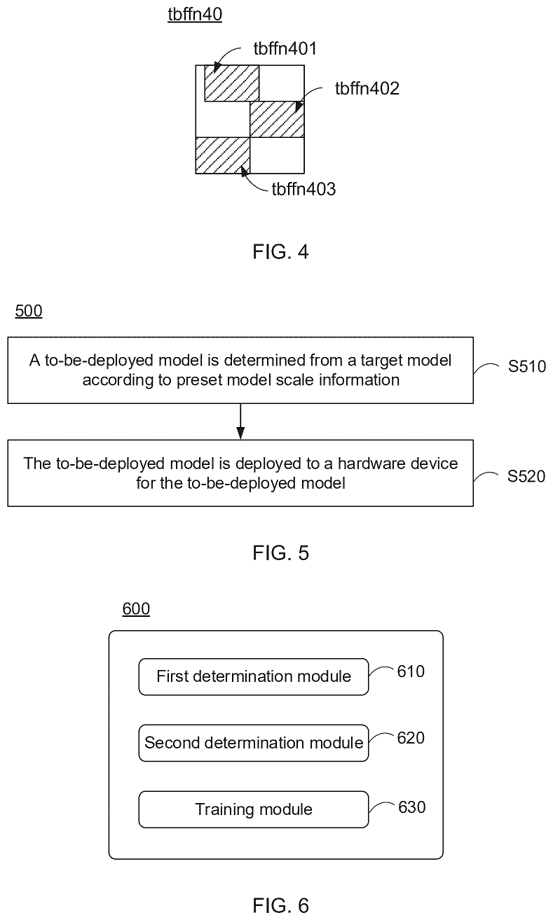

In some embodiments, the initial feedforward parameter matrix of the initial feedforward layer includes a plurality of initial feedforward parameters, and the to-be-trained feedforward data includes at least one to-be-trained feedforward parameter submatrix. The determining to-be-trained feedforward data of the to-be-trained feedforward layer from the initial feedforward layer includes: determining at least one initial feedforward parameter submatrix of the initial feedforward parameter matrix as the at least one to-be-trained feedforward parameter submatrix. This will be described below with reference to FIG. 4.

FIG. 4 shows a schematic diagram of an initial feedforward parameter matrix according to an embodiment of the present disclosure.

As shown in FIG. 4, an initial feedforward parameter matrix tbffn40 may include a plurality of initial feedforward parameters. An initial feedforward parameter submatrix tbffn401, an initial feedforward parameter submatrix tbffn402, and an initial feedforward parameter submatrix tbffn403 may be randomly determined from the initial feedforward parameter matrix tbffn40 as 3 to-be-trained feedforward parameter submatrices. In an example, matrix elements in the initial feedforward parameter matrix tbffn40 other than the initial feedforward parameter submatrix tbffn401, the initial feedforward parameter submatrix tbffn402, and the initial feedforward parameter submatrix tbffn403 may also be set to a preset value (0) to obtain a to-be-trained feedforward parameter matrix. The total parameter quantity of the plurality of to-be-trained feedforward parameter submatrices may be consistent with the parameter quantity indicated by the feedforward scale information for the initial feedforward layer.

It may be understood that the present disclosure is described above with reference to the initial attention layer and the initial feedforward layer of the initial processing module. However, the present disclosure is not limited to this, and the initial processing module may further include a plurality of initial expert units, which will be described below.

In some embodiments, the determining at least one to-be-trained module according to the at least one module scale information and a plurality of initial modules of an initial model includes: determining at least one initial expert unit among the plurality of initial expert units as at least one to-be-trained expert unit of the to-be-trained module according to module scale information for the initial module. The expert units may be Mixture of Experts (MoE) units. For example, taking the above-mentioned first module scale information as an example, if there are 16 initial expert units, 4 initial expert units may be randomly selected as the to-be-trained expert units. Through embodiments of the present disclosure, the number of expert units may be adjusted, which further enables the model to be efficiently deployed in various application scenarios with different hardware resources.

Through embodiments of the present disclosure, training of attention layers, feedforward layers, latent variables, expert units, and processing modules of different scales may be achieved, comprehensive elastic training is achieved, and richer elastic strategies are provided for model training.

It may be understood that some methods of determining the to-be-trained model are described above, and some methods of training the to-be-trained model will be described below.

In some embodiments, in some embodiments of the above-mentioned operation S130, text sample data may be tokenized to obtain text sample token data. The text sample token data is input into the at least one to-be-trained module, so as to process the text sample token data by using the at least one to-be-trained module to obtain a text sample result. The at least one to-be-trained module may be trained according to the text sample result and the label of the text sample data. In an example, the text sample data may be question text sample data, the text sample result may be an answer text sample result, and the label of the text sample data may be manually annotated a real answer text for the question text sample data.

It may be understood that the method of the present disclosure is described above with reference to the text sample data. However, the present disclosure is not limited to this, and the to-be-trained module may also be trained based on one or more of text sample data, image sample data, audio sample data, and video sample data. For example, taking the image sample data as an example, the above-mentioned initial embedding module may perform patch embedding processing on the image sample data to facilitate subsequent module processing. The image sample data is input into the at least one to-be-trained module, so as to process the image sample data by using the at least one to-be-trained module to obtain an image sample result. The at least one to-be-trained module may be trained according to the image sample result and the label of the image sample result. The image sample data may be, for example, a captured photo. The image sample result may be, for example, an anime-style image. The label of the image sample result may be, for example, a manually drawn anime image corresponding to the image sample data. For another example, audio sample data may be converted into a text, and then the at least one to-be-trained module may be trained by referring to the training method for the at least one to-be-trained module using text sample data.

It may be understood that the model training method of the present disclosure is described above, and the model deployment method of the present disclosure will be described below.

FIG. 5 shows a flowchart of a model deployment method according to another embodiment of the present disclosure.

As shown in FIG. 5, a method 500 may include operation S510 to operation S520.

In operation S510, a to-be-deployed model is determined from a target model according to preset model scale information.

It may be understood that the description of the preset model scale information above is also applicable to this embodiment and will not be described in detail herein.

In operation S520, the to-be-deployed model is deployed to a hardware device for the to-be-deployed model.

In embodiments of the present disclosure, the target model is obtained by training an initial model through the following operations: determining at least one module scale information according to the preset model scale information; determining at least one to-be-trained module according to the at least one module scale information and a plurality of initial modules of an initial model, where the to-be-trained module includes a to-be-trained parameter determined from the initial module according to the module scale information; and training the at least one to-be-trained module according to training sample data to obtain at least one trained module, where the training sample data is obtained from at least one of text sample data, image sample data, audio sample data, or video sample data. For example, the target model is obtained by training the initial model through the above-mentioned method 100.

In some embodiments, the preset model scale information includes a plurality of preset model scale parameters, and a preset parameter quantity indicated by the preset model scale parameter is less than or equal to an initial parameter quantity of the initial model. The determining at least one module scale information according to preset model scale information includes: determining a target model scale parameter from the plurality of preset model scale parameters according to a plurality of preset parameter probability values for the plurality of preset model scale parameters, where a preset parameter quantity indicated by the target model scale parameter is consistent with a to-be-trained parameter quantity for the at least one to-be-trained module; and determining the at least one module scale information for at least one of the plurality of initial modules according to the target model scale parameter.

In some embodiments, the determining the at least one module scale information for at least one of the plurality of initial modules according to the target model scale parameter includes: determining latent variable scale information and the at least one module scale information for at least one of the plurality of initial modules according to the target model scale parameter, where the latent variable scale information is used to indicate a scale of latent variables for the to-be-trained module.

In some embodiments, the determining at least one to-be-trained module according to the at least one module scale information and a plurality of initial modules of an initial model includes: determining a plurality of to-be-trained parameters included in the to-be-trained module from the initial module based on at least one of a plurality of sampling modes according to module scale information for the initial module, where the plurality of sampling modes include a random sampling mode.

In some embodiments, the initial module includes at least one of an initial attention layer or an initial feedforward layer, and the to-be-trained module includes at least one of a to-be-trained attention layer or a to-be-trained feedforward layer. The determining at least one to-be-trained module according to the at least one module scale information and a plurality of initial modules of an initial model includes at least one of: determining to-be-trained attention data of the to-be-trained attention layer from the initial attention layer according to module scale information for the initial module, where the to-be-trained attention data includes a plurality of to-be-trained attention parameters; or determining to-be-trained feedforward data of the to-be-trained feedforward layer from the initial feedforward layer according to module scale information for the initial module, where the to-be-trained feedforward data includes a plurality of to-be-trained feedforward parameters.

In some embodiments, the initial attention layer includes initial attention data of each of a plurality of initial attention heads, and the initial attention data includes an initial query parameter matrix, an initial key parameter matrix, and an initial value parameter matrix. The determining to-be-trained attention data of the to-be-trained attention layer from the initial attention layer includes: determining at least one of the initial attention data of at least one of the plurality of initial attention heads as at least one intermediate attention data of at least one to-be-trained attention head; and determining at least one of the to-be-trained attention data from the at least one intermediate attention data.

In some embodiments, the intermediate attention data includes an intermediate query parameter matrix, an intermediate key parameter matrix, and an intermediate value parameter matrix, and the to-be-trained attention data includes a to-be-trained query parameter matrix, a to-be-trained key parameter matrix, and a to-be-trained value parameter matrix. The determining at least one of the to-be-trained attention data from the at least one intermediate attention data includes at least one of: determining at least one intermediate query parameter submatrix in the intermediate query parameter matrix as at least one to-be-trained query parameter submatrix of the to-be-trained query parameter matrix; determining at least one intermediate key parameter submatrix in the intermediate key parameter matrix as at least one to-be-trained key parameter submatrix of the to-be-trained key parameter matrix; or determining at least one intermediate value parameter submatrix in the intermediate value parameter matrix as at least one to-be-trained value parameter submatrix of the to-be-trained value parameter matrix.

In some embodiments, an initial feedforward parameter matrix of the initial feedforward layer includes a plurality of initial feedforward parameters, and the to-be-trained feedforward data includes at least one to-be-trained feedforward parameter submatrix. The determining to-be-trained feedforward data of the to-be-trained feedforward layer from the initial feedforward layer includes: determining at least one initial feedforward parameter submatrix of the initial feedforward parameter matrix as the at least one to-be-trained feedforward parameter submatrix.

In some embodiments, the initial module includes a plurality of initial expert units. The determining at least one to-be-trained module according to the at least one module scale information and a plurality of initial modules of an initial model includes: determining at least one initial expert unit in the plurality of initial expert units as at least one to-be-trained expert unit of the to-be-trained module according to module scale information for the initial module.

It may be understood that the method of the present disclosure is described above, and the apparatus of the present disclosure will be described below.

FIG. 6 shows a block diagram of a model training apparatus according to an embodiment of the present disclosure.

As shown in FIG. 6, an apparatus 600 may include a first determination module 610, a second determination module 620, and a training module 630.

The first determination module 610 is used to determine at least one module scale information according to the preset model scale information.

The second determination module 620 is used to determine at least one to-be-trained module according to the at least one module scale information and a plurality of initial modules of an initial model, where the to-be-trained module includes a to-be-trained parameter determined from the initial module according to the module scale information.

The training module 630 is used to train the at least one to-be-trained module according to training sample data to obtain at least one trained module, where the training sample data is obtained from at least one of text sample data, image sample data, audio sample data, or video sample data.

In some embodiments, the preset model scale information includes a plurality of preset model scale parameters, and a preset parameter quantity indicated by the preset model scale parameter is less than or equal to an initial parameter quantity of the initial model. The first determination module includes: a first determination sub-module used to determine a target model scale parameter from the plurality of preset model scale parameters according to a plurality of preset parameter probability values for the plurality of preset model scale parameters, where a preset parameter quantity indicated by the target model scale parameter is consistent with a to-be-trained parameter quantity for the at least one to-be-trained module; and a second determination sub-module used to determine the at least one module scale information for at least one of the plurality of initial modules according to the target model scale parameter.

In some embodiments, the second determination sub-module is further used to: determine latent variable scale information and the at least one module scale information for at least one of the plurality of initial modules according to the target model scale parameter, where the latent variable scale information is used to indicate a scale of latent variables for the to-be-trained module.

In some embodiments, the second determination module includes: a third determination sub-module used to determine a plurality of to-be-trained parameters included in the to-be-trained module from the initial module based on at least one of a plurality of sampling modes according to module scale information for the initial module, where the plurality of sampling modes include a random sampling mode.

In some embodiments, the initial module includes at least one of an initial attention layer or an initial feedforward layer, and the to-be-trained module includes at least one of a to-be-trained attention layer or a to-be-trained feedforward layer. The second determination module includes at least one of: a fourth determination sub-module used to determine to-be-trained attention data of the to-be-trained attention layer from the initial attention layer according to module scale information for the initial module, where the to-be-trained attention data includes a plurality of to-be-trained attention parameters; or a fifth determination sub-module used to determine to-be-trained feedforward data of the to-be-trained feedforward layer from the initial feedforward layer according to module scale information for the initial module, where the to-be-trained feedforward data includes a plurality of to-be-trained feedforward parameters.

In some embodiments, the initial attention layer includes initial attention data of each of a plurality of initial attention heads, and the initial attention data includes an initial query parameter matrix, an initial key parameter matrix, and an initial value parameter matrix. The fourth determination sub-module includes: a first determination unit used to determine at least one of the initial attention data of at least one of the plurality of initial attention heads as at least one intermediate attention data of at least one to-be-trained attention head; and a second determination unit used to determine at least one of the to-be-trained attention data from the at least one intermediate attention data.

In some embodiments, the intermediate attention data includes an intermediate query parameter matrix, an intermediate key parameter matrix, and an intermediate value parameter matrix, and the to-be-trained attention data includes a to-be-trained query parameter matrix, a to-be-trained key parameter matrix, and a to-be-trained value parameter matrix. The second determination unit includes at least one of: a first determination sub-unit used to determine at least one intermediate query parameter submatrix in the intermediate query parameter matrix as at least one to-be-trained query parameter submatrix of the to-be-trained query parameter matrix; a second determination sub-unit used to determine at least one intermediate key parameter submatrix in the intermediate key parameter matrix as at least one to-be-trained key parameter submatrix of the to-be-trained key parameter matrix; or a third determination sub-unit used to determine at least one intermediate value parameter submatrix in the intermediate value parameter matrix as at least one to-be-trained value parameter submatrix of the to-be-trained value parameter matrix.

In some embodiments, an initial feedforward parameter matrix of the initial feedforward layer includes a plurality of initial feedforward parameters, and the to-be-trained feedforward data includes at least one to-be-trained feedforward parameter submatrix. The fifth determination sub-module includes: a third determination unit used to determine at least one initial feedforward parameter submatrix of the initial feedforward parameter matrix as the at least one to-be-trained feedforward parameter submatrix.

In some embodiments, the initial module includes a plurality of initial expert units. The second determination module includes: a sixth determination sub-module used to determine at least one initial expert unit in the plurality of initial expert units as at least one to-be-trained expert unit of the to-be-trained module according to module scale information for the initial module.

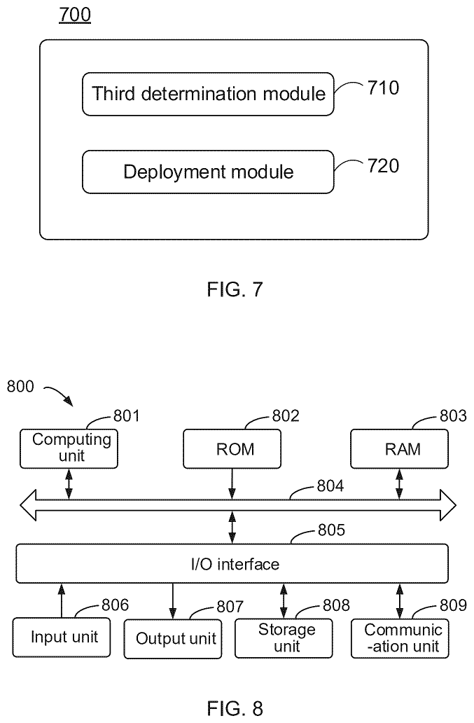

FIG. 7 shows a block diagram of a model deployment apparatus according to an embodiment of the present disclosure.

As shown in FIG. 7, an apparatus 700 may include a third determination module 710 and a deployment module 720.

The third determination module 710 is used to determine a to-be-deployed model from a target model according to preset model scale information.

The deployment module 720 is used to deploy the to-be-deployed model to a hardware device for the to-be-deployed model.

In some embodiments, the target model is obtained by training an initial model by performing relevant operations in the following modules: a first determination module used to determine at least one module scale information according to the preset model scale information; a second determination module used to determine at least one to-be-trained module according to the at least one module scale information and a plurality of initial modules of an initial model, where the to-be-trained module includes a to-be-trained parameter determined from the initial module according to the module scale information; a training module used to train the at least one to-be-trained module according to training sample data to obtain at least one trained module, where the training sample data is obtained from at least one of text sample data, image sample data, audio sample data, or video sample data. For example, the target model may be obtained by training the initial model using the above-mentioned apparatus 600. The description of the apparatus 600 above is also applicable to this embodiment and will not be described in detail herein.

In the technical solution of the present disclosure, the processes of collecting, storing, using, processing, transmitting, providing, and disclosing user personal information involved comply with the provisions of relevant laws and regulations, and do not violate public order and good customs.

According to embodiments of the present disclosure, the present disclosure further provides an electronic device, a readable storage medium, and a computer program product.

FIG. 8 shows a schematic block diagram of an exemplary electronic device 800 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, the device 800 includes a computing unit 801 which may perform various appropriate actions and processes according to a computer program stored in a read only memory (ROM) 802 or a computer program loaded from a storage unit 808 into a random access memory (RAM) 803. In the RAM 803, various programs and data necessary for an operation of the device 800 may also be stored. The computing unit 801, the ROM 802 and the RAM 803 are connected to each other through a bus 804. An input/output (I/O) interface 805 is also connected to the bus 804.

A plurality of components in the device 800 are connected to the input/output (I/O) interface 805, including: an input unit 806, such as a keyboard, or a mouse; an output unit 807, such as displays or speakers of various types; a storage unit 808, such as a disk, or an optical disc; and a communication unit 809, such as a network card, a modem, or a wireless communication transceiver. The communication unit 809 allows the device 800 to exchange information/data with other devices through a computer network such as Internet and/or various telecommunication networks.

The computing unit 801 may be various general-purpose and/or dedicated processing assemblies having processing and computing capabilities. Some examples of the computing units 801 include, but are not limited to, a central processing unit (CPU), a graphics processing unit (GPU), various dedicated artificial intelligence (AI) computing chips, various computing units that run machine learning model algorithms, a digital signal processor (DSP), and any suitable processor, controller, microcontroller, etc. The computing unit 801 executes various methods and processes described above, such as at least one of the model training method or the model deployment method. For example, in some embodiments, at least one of the model training method or the model deployment method may be implemented as a computer software program which is tangibly embodied in a machine-readable medium, such as the storage unit 808. In some embodiments, the computer program may be partially or entirely loaded and/or installed in the device 800 via the ROM 802 and/or the communication unit 809. The computer program, when loaded in the RAM 803 and executed by the computing unit 801, may execute one or more steps in at least one of the model training method or the model deployment method described above. Alternatively, in other embodiments, the computing unit 801 may be used to perform at least one of the model training method or the model deployment method by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM) or a flash memory, an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A model training method, comprising:
determining at least one module scale information according to preset model scale information;
determining at least one to-be-trained module according to the at least one module scale information and a plurality of initial modules of an initial model, wherein the to-be-trained module comprises a to-be-trained parameter determined from the initial module according to the module scale information; and
training the at least one to-be-trained module according to training sample data to obtain at least one trained module, wherein the training sample data is obtained from at least one of text sample data, image sample data, audio sample data, or video sample data.

2. The method according to claim 1, wherein the preset model scale information comprises a plurality of preset model scale parameters, and a preset parameter quantity indicated by the preset model scale parameter is less than or equal to an initial parameter quantity of the initial model;
the determining at least one module scale information according to preset model scale information comprises:
determining a target model scale parameter from the plurality of preset model scale parameters according to a plurality of preset parameter probability values for the plurality of preset model scale parameters, wherein a preset parameter quantity indicated by the target model scale parameter is consistent with a to-be-trained parameter quantity for the at least one to-be-trained module; and
determining the at least one module scale information for at least one of the plurality of initial modules according to the target model scale parameter.

3. The method according to claim 2, wherein the determining the at least one module scale information for at least one of the plurality of initial modules according to the target model scale parameter comprises:
determining latent variable scale information and the at least one module scale information for at least one of the plurality of initial modules according to the target model scale parameter, wherein the latent variable scale information indicates a scale of latent variables for the to-be-trained module.

4. The method according to claim 1, wherein the determining at least one to-be-trained module according to the at least one module scale information and a plurality of initial modules of an initial model comprises:
determining, from the initial module, a plurality of to-be-trained parameters comprised in the to-be-trained module based on at least one of a plurality of sampling modes according to module scale information for the initial module, wherein the plurality of sampling modes comprise a random sampling mode.

5. The method according to claim 1, wherein the initial module comprises at least one of an initial attention layer or an initial feedforward layer, and the to-be-trained module comprises at least one of a to-be-trained attention layer or a to-be-trained feedforward layer;
the determining at least one to-be-trained module according to the at least one module scale information and a plurality of initial modules of an initial model comprises at least one of:
determining to-be-trained attention data of the to-be-trained attention layer from the initial attention layer according to module scale information for the initial module, wherein the to-be-trained attention data comprises a plurality of to-be-trained attention parameters; or
determining to-be-trained feedforward data of the to-be-trained feedforward layer from the initial feedforward layer according to module scale information for the initial module, wherein the to-be-trained feedforward data comprises a plurality of to-be-trained feedforward parameters.

6. The method according to claim 5, wherein the initial attention layer comprises respective initial attention data of a plurality of initial attention heads, and the initial attention data comprises an initial query parameter matrix, an initial key parameter matrix, and an initial value parameter matrix;
the determining to-be-trained attention data of the to-be-trained attention layer from the initial attention layer comprises:
determining at least one initial attention data of at least one of the plurality of initial attention heads as at least one intermediate attention data of at least one to-be-trained attention head; and
determining at least one to-be-trained attention data from the at least one intermediate attention data.

7. The method according to claim 6, wherein the intermediate attention data comprises an intermediate query parameter matrix, an intermediate key parameter matrix, and an intermediate value parameter matrix, and the to-be-trained attention data comprises a to-be-trained query parameter matrix, a to-be-trained key parameter matrix, and a to-be-trained value parameter matrix;
the determining at least one to-be-trained attention data from the at least one intermediate attention data comprises at least one of:
determining at least one intermediate query parameter submatrix in the intermediate query parameter matrix as at least one to-be-trained query parameter submatrix of the to-be-trained query parameter matrix;
determining at least one intermediate key parameter submatrix in the intermediate key parameter matrix as at least one to-be-trained key parameter submatrix of the to-be-trained key parameter matrix; or
determining at least one intermediate value parameter submatrix in the intermediate value parameter matrix as at least one to-be-trained value parameter submatrix of the to-be-trained value parameter matrix.

8. The method according to claim 6, wherein an initial feedforward parameter matrix of the initial feedforward layer comprises a plurality of initial feedforward parameters, and the to-be-trained feedforward data comprises at least one to-be-trained feedforward parameter submatrix;
the determining to-be-trained feedforward data of the to-be-trained feedforward layer from the initial feedforward layer comprises:
determining at least one initial feedforward parameter submatrix of the initial feedforward parameter matrix as the at least one to-be-trained feedforward parameter submatrix.

9. The method according to claim 1, wherein the initial module comprises a plurality of initial expert units;
the determining at least one to-be-trained module according to the at least one module scale information and a plurality of initial modules of an initial model comprises:
determining at least one initial expert unit among the plurality of initial expert units as at least one to-be-trained expert unit of the to-be-trained module according to module scale information for the initial module.

10. A model deployment method, comprising:
determining a to-be-deployed model from a target model according to preset model scale information;
deploying the to-be-deployed model to a hardware device for the to-be-deployed model, wherein the target model is obtained by training an initial model through:
determining at least one module scale information according to the preset model scale information;
determining at least one to-be-trained module according to the at least one module scale information and a plurality of initial modules of an initial model, wherein the to-be-trained module comprises a to-be-trained parameter determined from the initial module according to the module scale information; and
training the at least one to-be-trained module according to training sample data to obtain at least one trained module, wherein the training sample data is obtained from at least one of text sample data, image sample data, audio sample data, or video sample data.

11. An electronic device, comprising:
at least one processor; and
a memory communicatively connected to the at least one processor,
wherein the memory stores instructions executable by the at least one processor, and the instructions, when executed by the at least one processor, are configured to cause the at least one processor to at least:
determine at least one module scale information according to preset model scale information;
determine at least one to-be-trained module according to the at least one module scale information and a plurality of initial modules of an initial model, wherein the to-be-trained module comprises a to-be-trained parameter determined from the initial module according to the module scale information; and
train the at least one to-be-trained module according to training sample data to obtain at least one trained module, wherein the training sample data is obtained from at least one of text sample data, image sample data, audio sample data, or video sample data.

12. The electronic device according to claim 11, wherein the preset model scale information comprises a plurality of preset model scale parameters, and a preset parameter quantity indicated by the preset model scale parameter is less than or equal to an initial parameter quantity of the initial model;
the instructions are further configured to cause the at least one processor to at least:
determine a target model scale parameter from the plurality of preset model scale parameters according to a plurality of preset parameter probability values for the plurality of preset model scale parameters, wherein a preset parameter quantity indicated by the target model scale parameter is consistent with a to-be-trained parameter quantity for the at least one to-be-trained module; and
determine the at least one module scale information for at least one of the plurality of initial modules according to the target model scale parameter.

13. The electronic device according to claim 12, wherein the instructions are further configured to cause the at least one processor to at least:
determine latent variable scale information and the at least one module scale information for at least one of the plurality of initial modules according to the target model scale parameter, wherein the latent variable scale information indicates a scale of latent variables for the to-be-trained module.

14. The electronic device according to claim 11, wherein the instructions are further configured to cause the at least one processor to at least: determine, from the initial module, a plurality of to-be-trained parameters comprised in the to-be-trained module based on at least one of a plurality of sampling modes according to module scale information for the initial module, wherein the plurality of sampling modes comprise a random sampling mode.

15. The electronic device according to claim 11, wherein the initial module comprises at least one of an initial attention layer or an initial feedforward layer, and the to-be-trained module comprises at least one of a to-be-trained attention layer or a to-be-trained feedforward layer;
the instructions are further configured to cause the at least one processor to perform at least one of the following operations:
determining to-be-trained attention data of the to-be-trained attention layer from the initial attention layer according to module scale information for the initial module, wherein the to-be-trained attention data comprises a plurality of to-be-trained attention parameters; or
determining to-be-trained feedforward data of the to-be-trained feedforward layer from the initial feedforward layer according to module scale information for the initial module, wherein the to-be-trained feedforward data comprises a plurality of to-be-trained feedforward parameters.

16. The electronic device according to claim 15, wherein the initial attention layer comprises respective initial attention data of a plurality of initial attention heads, and the initial attention data comprises an initial query parameter matrix, an initial key parameter matrix, and an initial value parameter matrix;
the instructions are further configured to cause the at least one processor to at least:
determine at least one initial attention data of at least one of the plurality of initial attention heads as at least one intermediate attention data of at least one to-be-trained attention head; and
determine at least one to-be-trained attention data from the at least one intermediate attention data.

17. The electronic device according to claim 16, wherein the intermediate attention data comprises an intermediate query parameter matrix, an intermediate key parameter matrix, and an intermediate value parameter matrix, and the to-be-trained attention data comprises a to-be-trained query parameter matrix, a to-be-trained key parameter matrix, and a to-be-trained value parameter matrix;
the instructions are further configured to cause the at least one processor to perform at least one of the following operations:
determining at least one intermediate query parameter submatrix in the intermediate query parameter matrix as at least one to-be-trained query parameter submatrix of the to-be-trained query parameter matrix;
determining at least one intermediate key parameter submatrix in the intermediate key parameter matrix as at least one to-be-trained key parameter submatrix of the to-be-trained key parameter matrix; or
determining at least one intermediate value parameter submatrix in the intermediate value parameter matrix as at least one to-be-trained value parameter submatrix of the to-be-trained value parameter matrix.

18. An electronic device, comprising:
at least one processor; and
a memory communicatively connected to the at least one processor,
wherein the memory stores instructions executable by the at least one processor, and the instructions, when executed by the at least one processor, are configured to cause the at least one processor to implement the method according to claim 10.

19. A non-transitory computer-readable storage medium having computer instructions therein, wherein the computer instructions are configured to cause a computer to implement the method according to claim 1.

20. A non-transitory computer-readable storage medium having computer instructions therein, wherein the computer instructions are configured to cause a computer to implement the method according to claim 10.
